(19) United States
(12) Patent Application Publication
(10) Pub. No.: US 2005/0285746 A1
(43) Pub. Date: Dec. 29, 2005

(54) Radio frequency identification based system to track consumption of medication

(76) Inventors: Uttam K. Sengupta, Portland, OR (US); Nikhil M. Deshpande, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/973,564

(22) Filed: Oct. 25, 2004

Related U.S. Application Data
(63) Continuation-in-part of application No. 10/877,734, filed on Jun. 25, 2004.

(51) Int. Cl. G08B 23/00

(52) U.S. Cl. 340/573.1; 340/572.1

(57) ABSTRACT

A radio frequency identification (RFID) based system to track consumption of medicine is disclosed. An RFID device monitors for a signal pattern indicative of an RFID tag contained within medication and determines a status based on a presence or absence of the signal pattern. The signal pattern includes a medication identifier and a signal level over time. A detected signal pattern is compared to stored ingestion profiles to distinguish between consumed and non-consumed medication.

### CROSS REFERENCES TO RELATED APPLICATIONS

This application is a continuation-in-part of co-pending U.S. patent application Ser. No. 10/877,734 filed on Jun. 25, 2004.

### BACKGROUND

### DESCRIPTION OF THE RELATED ART

As the general population becomes older and/or sicker, there may be an increased need for remote monitoring. For example, an aging adult on prescription medication may choose to live alone or a patient with a critical illness such as cancer may be required to take a combination of medication. With age or sickness, memory capability may decrease and a patient may take incorrect dosages or combinations of medicine. Physicians currently need to resort to regular blood and other such tests to determine if the proper medication was taken. Missed or incorrect dosages of medicine may cause serious side effects.

### BRIEF DESCRIPTION OF THE DRAWINGS

The present invention may be better understood, and its numerous features and advantages made apparent to those skilled in the art by referencing the accompanying drawings.

FIG. 1 illustrates a system for remote monitoring consumption of medication according to an embodiment of the present invention.

FIG. 2 illustrates a flow diagram of remote client monitoring at a client site according to an embodiment of the present invention.

FIG. 3 illustrates a flow diagram of remote client monitoring at a monitoring site according to an embodiment of the present invention.

FIG. 4 illustrates an alternate system for remote monitoring consumption of medication according to an embodiment of the present invention.

FIG. 5 illustrates a flow diagram of remote client monitoring using a monitoring device according to an embodiment of the present invention.

FIG. 6 illustrates a sample ingestion profile according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

Types of wireless communication systems intended to be within the scope of the present invention include, although not limited to, Wireless Local Area Network (WLAN), Wireless Wide Area Network (WWAN), Worldwide Interoperability for Microwave Access (WiMax), Wireless Personal Area Network (WPAN), Wireless Metropolitan Area Network (WMAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, Universal Mobile Telecommunications System (UMTS), and the like, although the scope of the invention is not limited in this respect.

In at least one implementation, for example, a wireless link is implemented in accordance with the Bluetooth short range wireless protocol (Specification of the Bluetooth System, Version 1.2, Bluetooth SIG, Inc., November 2003, and related specifications and protocols). Other possible wireless networking standards include, for example: IEEE 802.11 (ANSI/IEEE Std 802.11-1999 Edition and related standards), IEEE 802.16 (ANSI/IEEE Std 802.16-2002, IEEE Std 802.16a, March, 2003 and related standards), HIPERLAN 1, 2 and related standards developed by the European Telecommunications Standards Institute (ETSI) Broadband Radio Access Networks (BRAN), HomeRF (HomeRF Specification, Revision 2.01, The HomeRF Technical Committee, July, 2002 and related specifications), and/or others.

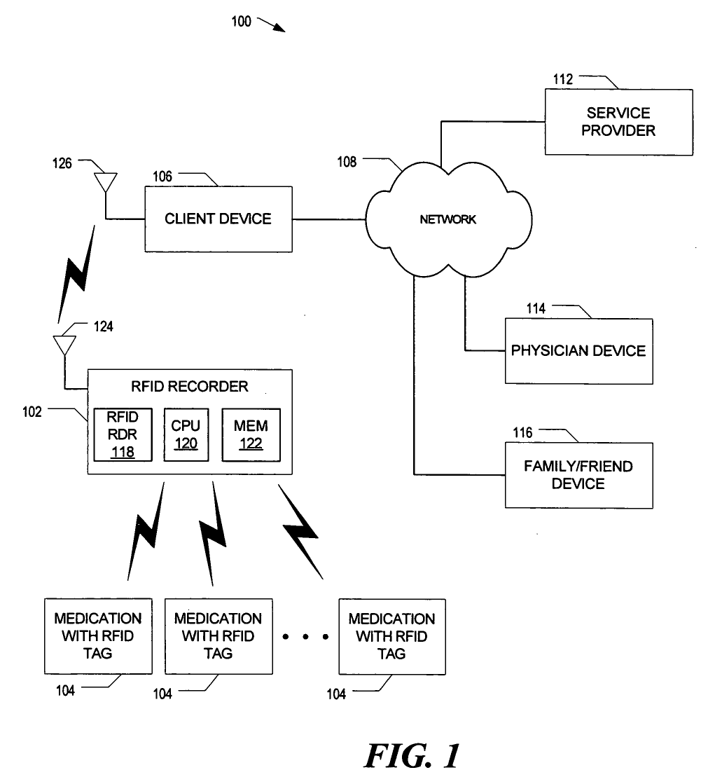

FIG. 1 illustrates a system 100 for remote monitoring consumption of medication according to an embodiment of the present invention. System 100 may include a recording device 102 in wireless communication with multiple radio frequency identification (RFID) tags contained within client medication 104. Recording device 102 may be in wireless communication with client device 106. Client device 106 may be connected to network 108. A service provider 112, a physician device 114 and a family/friend device 116 may also be connected to network 108. Although monitoring system 100 comprises a limited number of nodes as shown in FIG. 1, it may be appreciated that system 100 may comprise any number of additional nodes in any number of different network topologies. The embodiments are not limited in this context.

Client medication 104 may include pills, tablets, capsules or other form of medication having an edible and safe for human consumption RFID tag. Consumable RFID tags have been used to track salmon and other fish migration and spawning patterns. Each different type of medication may have a different unique RFID. The RFID tags may be passive, although embodiments are not limited in this context. Passive RFID tags transmit a stream of information in response to an interrogation signal, such as an electro-magnetic signal at a predetermined operating frequency. Passive RFID tags typically have no power source, and rely upon the energy delivered by the interrogation signal to transit the stream of information. Active RFID tags may have a power source such as a direct current (DC) battery. Active RFID tags may transmit a stream of information on a continuous basis, a periodic basis, or in response to some external event.

In one embodiment, recording device 102 collects monitoring information and transmits the information to the client device 106. Recording device 102 may be integrated into a device worn by a monitored person, such as a watch, necklace, ring, eyeglass, and other unobtrusive forms that may be worn on the body. Recording device 102 scans the monitored person for the consumption of particular pills. Particular pills are identified using RFID tags. The type of medicine and the amount of medicine consumed may be monitored.

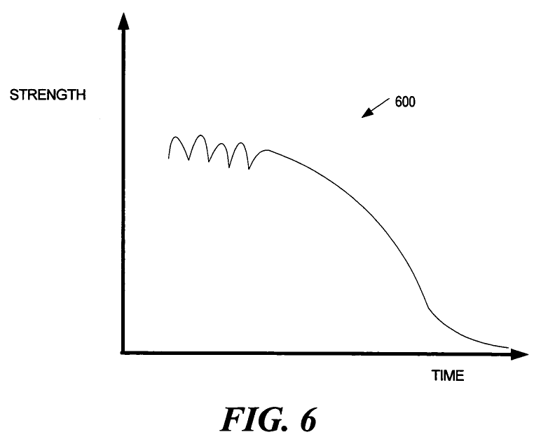

Consumption of medicine may be distinguished from medicine in ajar or in a client's pocket in a variety of manners. For example, as a particular pill is consumed, the RFID signal pattern transmitted changes over time. The signal pattern may be come weaker along a known consumption curve. Alternatively, the signal pattern may change as the pill is consumed, for example, as particular components are dissolved due to stomach acids. Experiments may be conducted to create known ingestion profiles for specific medication in a controlled environment. Ingestion profiles may be created for a variety of detection devices. In addition, ingestion profiles for various user positions such as upright (standing, sitting, walking) versus prone (lying) may be used. A sample ingestion profile is illustrated in FIG. 6.

In various embodiments of the present invention, comparison of the signal pattern to an ingestion profile may be performed by any component in the system, for example, recording device 102, client device 106, or service provider 112. The embodiments are not limited in this context.

Recording device 102 may include, for example, an RFID reader 118, a central processing unit 120, memory 122 for storing monitoring data, and one or more antennas 124 to communicate recorded RFID signal pattern information to client device 106. In one embodiment, recording device 102 may transmit information previously stored in memory. The embodiments are not limited in this context.

Client device 106 may comprise any processing system arranged to communicate monitoring information between recording device 102 and network 108. Examples of client device 106 may include a personal computer (PC), laptop computer, ultra-portable computer, handheld computer, cellular telephone, personal digital assistant (PDA), client capability built into an access point, smart phone, and the like. For example, client device 106 may comprise a PC having client application software. The client application software may be an agent for a monitoring service provider that is arranged to interact with server application software to provide monitoring services. The client application software may be arranged to perform a number of different client operations, such as subscribe to a monitoring service, receive configuration and control information for client device 106 and recording device 102, perform tests for various devices, perform authentication and encryption operations, send monitoring information to server 108 via network 106, and so forth. In standard operating mode, for example, client device 106 may occasionally synchronize with recording device 102 and receive its monitoring information, open a data connection with service provider 112 via network 108, and communicate the monitoring information to service provider 112, physician device 114, or family/friend device 116. Similarly, service provider 112 may communicate control or configuration information to client device 106 and/or recording device 102 via network 108. The embodiments are not limited in this context.

Client device 106 may include one or more antennas 126 for communicating with recording device 102. In one embodiment, recording device 102 and client device 106 may communicate information in accordance with a number of different wireless protocols. Examples of such wireless protocols may include the 802.11 family of protocols, Bluetooth, Ultra Wide Band (UWB), and so forth. The embodiments are not limited in this context.

In one embodiment, system 100 may include network 108. Network 108 may comprise any type of network arranged to communicate information between the various nodes of system 100. For example, network 108 may comprise a packet data network such as a Local Area Network (LAN) or Wide Area Network (WAN), a Public Switched Telephone Network (PSTN), a wireless network such as cellular telephone network or satellite network, or WLAN, WMAN, WWAN, or any combination thereof. Network 108 may communicate information in accordance with any number of different data communication protocols, such as one or more Ethernet protocols, one or more Internet protocols such as the Transport Control Protocol (TCP) Internet Protocol (IP), Wireless Access Protocol (WAP), and so forth. The embodiments are not limited in this context.

In one embodiment, service provider 112 may receive monitoring information from client device 106 via network 108. In general operation, system 100 may operate to allow a first person to remotely monitor a second person. Physician device 114 and/or family/friend device 116 may receive monitoring information from service provider 112 or directly from client device 106. Service provider 112, physician device 114, and family/friend device 116 may use the monitoring information to generate status information that allows a user to quickly assess the health or physical status of a monitored person.

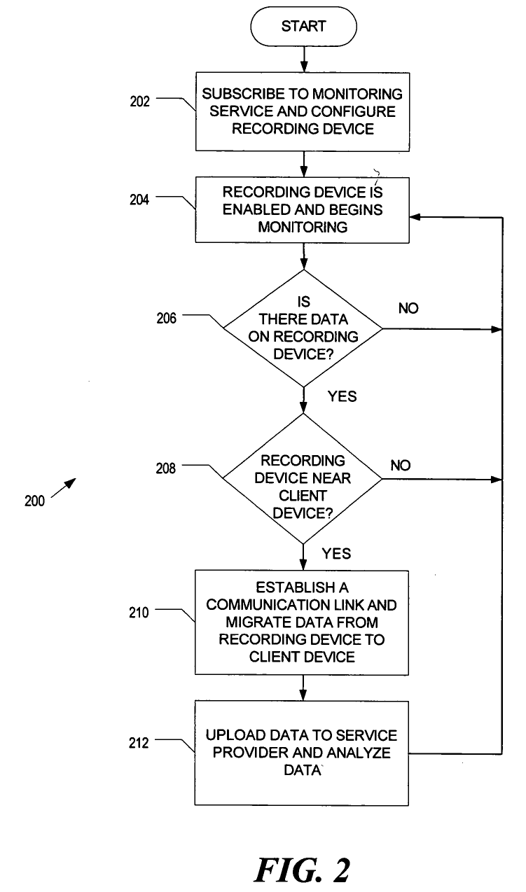

FIG. 2 illustrates a flow diagram 200 of remote client monitoring at a client site according to an embodiment of the present invention. A monitored person or someone acting on their behalf subscribes to a monitoring service and configures a recording device, block 202. Subscribing to a monitoring service and configuring the recording device may include the monitored person launching a client program on the client device, for example, a personal computer. The client program may guide the user through a sign up process, for example, prompting for user name and password, an identification of others who would access the monitoring data such as a physician, a family memory or a friend. Security checks required for authentication, for example, a public key, biometrics, and the like may be configured. The service provider may send a nominally configured device such as watch or locket and the client may complete the configuration by testing whether the device is able to interact with RFID tags.

The recording device is enabled, and begins monitoring the client, block 204. The monitored person, wearing the recording device, resumes normal activity and ingests medication. The recording device may detect an RFID signal at a certain threshold level (to indicate, for example, that the patient is holding a medication bottle) and may activate the recording software. The recording device may record information such as a data/time stamp, a unique identification of the medication, a signal strength, and an upright or prone status of the client.

Occasionally, the recording device determines if monitoring information is available for download to the client device, block 206. This determination may occur on a periodic basis, amount of information to download basis, or other condition. The invention is not limited in this context. If not, monitoring continues, block 204. If information is available for download, the recording device determines if the client device is within range, block 208. If not, monitoring continues, block 204. If the recording device is within a proximity of the client device for accurate download, a communication link between the recording device and the client device is established and data is downloaded, block 210. Periodically, the client device uploads the monitoring information to the service provider, block 212. The service provider may analyze the data, comparing for example, the data to known medication ingestion profiles. In an alternate embodiment, the client device or the recording device compares the data to known medication ingestion profiles.

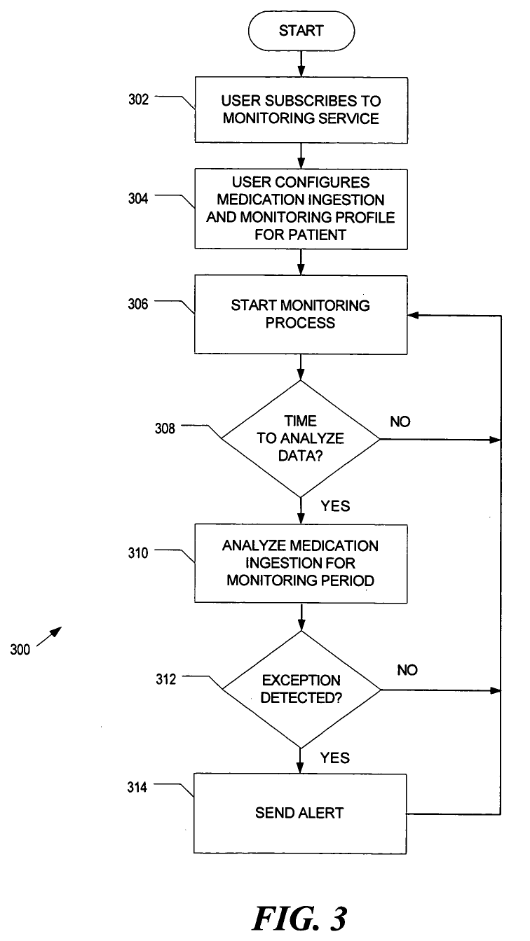

FIG. 3 illustrates a flow diagram of remote client monitoring at a monitoring site according to an embodiment of the present invention. Flow 300 illustrates the server-end of the client-server system and handles the interaction with the clients such as the sign up process, configuration, user authentication, data upload, data download, and the like. A user, for example, a person to be monitored or someone acting on their behalf such as a physician, a family member or a friend, subscribes to the monitoring service, block 302. The user configures the patients expected medication ingestion information and a monitoring profile for the patient. For example, thresholds for alerts may be set, types of medication and dosage information may be configured. The monitoring process is started and monitoring commences receiving monitoring data from a client device via, for example, a network, block 306. A determination is made whether the gathered data should be analyzed, block 308. If not, monitoring continues, block 306. If the data is to be analyzed, the received monitoring information for the monitoring period is analyzed, block 310. A determination is made whether an exception is detected, block 312. An exception could occur when, for example, a critical dosage is missed, wrong medication is taken, or too much medication is taken. If no exception is detected, monitoring continues, block 306. If an exception is detected, an alert is sent, block 314. The alert may be sent to a physician, a family member or a friend. For emergency conditions, an alert may be sent to a local 911 service for immediate care.

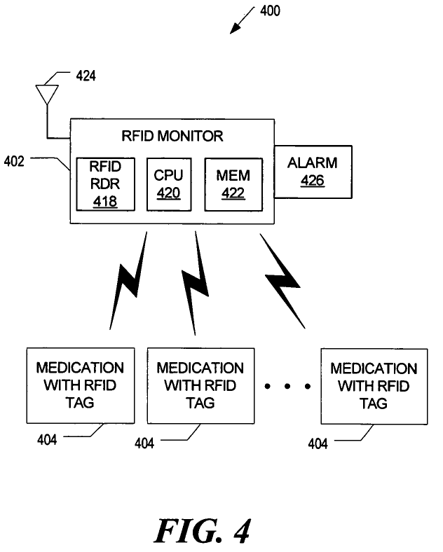

FIG. 4 illustrates an alternate system 400 for remote monitoring consumption of medication according to an embodiment of the present invention. System 400 may include a monitoring device 402 in wireless communication with multiple radio frequency identification (RFID) tags contained within client medication 404. Monitoring device 402 may include, for example, an RFID reader 418, a central processing unit 420, memory 422 for storing monitoring data, one or more antennas 424 to communicate with an external device (not shown), and an alarm unit 426. Monitoring device 402 is a self contained unit that is capable of monitoring for signal patterns, comparing the signal patterns to known ingestion profiles, and comparing identified medications to a patient profile of expected medication patterns. If any deviation from the expected medication pattern is detected, an alarm such as an audible alarm or warning light can be initiated via alarm unit 426. Alternatively, an alarm message may be sent via antenna 424 to the external device. The external device may be an external alarm bell or warning light, for example, at a nurse's station. The external device may also be a service provider device 112, physician device 114 or family/friend device 116 of FIG. 1. Monitoring device 402 may be programmable via antenna 424 or by a temporary physical connection such as a USB port (not shown).

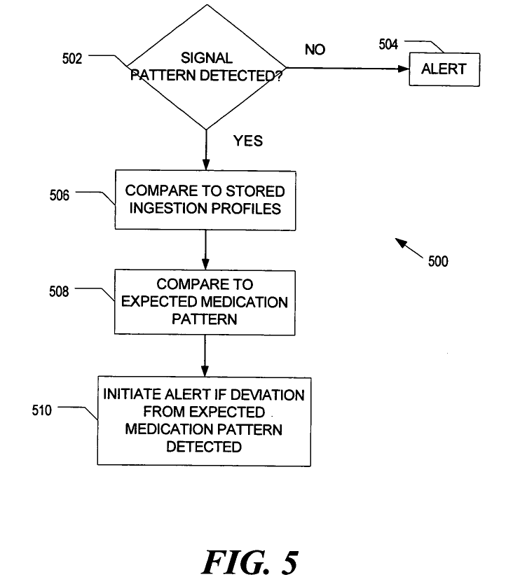

FIG. 5 illustrates a flow diagram 500 of remote client monitoring using monitoring device 402 according to an embodiment of the present invention. A signal pattern indicative of a RFID tag contained within medication is monitored for, block 502. If an expected signal pattern is not detected, an alert is initiated, block 504. A detected signal pattern is compared to known ingestion profiles to identify a medication, block 506. This may include a comparison of the RFID tag and a signal strength over time to stored ingestion profiles. Any identified medication is compared to the patient's expected medication pattern, block 508. For example, the quantity of medication and the timing of the medicating may be assessed. An alert is initiated if a deviation from the expected medication pattern is detected, block 510.

FIG. 6 illustrates a sample ingestion profile according to an embodiment of the present invention. As illustrated, the strength of profile 600 is initially erratic, for example, as the medication is removed from a bottle, counted by the patient. As the medication is ingested, the strength of the signal decreases over time. In alternate embodiments, RFIDs contained within medication can be constructed, for example, with dissolvable materials, to produce unique ingestion profiles where the information transmitted changes over time, allowing accurate medication identification.

Embodiments of the present invention provide a novel way to keep track of patients when they are self medicating themselves. Embodiments of the present invention will allow physicians to monitor remotely the medication ingestion patterns and proactively take action if patients miss a dose or take the incorrect dosage of medication.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

1. A method comprising:
monitoring for a signal pattern indicative of a radio frequency identification (RFID) tag contained within medication; and
determining a status based on a presence or an absence of the signal pattern.

2. The method as recited in claim 1, wherein the determining the status comprises identifying an RFID of the medication and an expected change in a signal strength over time.

3. The method as recited in claim 1, wherein the determining the status comprises determining the absence of the signal pattern when a particular signal pattern is expected.

4. The method as recited in claim 1, wherein the determining the status comprises determining the presence of the signal pattern when the signal pattern is not expected.

5. The method as recited in claim 1, wherein the determining the status comprises comparing a detected signal pattern to a stored ingestion profile to identify a consumed medication.

6. The method as recited in claim 5, wherein the stored ingestion profile includes an expected RFID.

7. The method as recited in claim 5, wherein the consumed medication is compared to a patient medication profile to identify a deviation from expected medicating.

8. The method as recited in claim 1, further comprising initiating an alert if the status indicates an incorrect medicating.

9. An apparatus comprising:
a radio frequency identification (RFID) reader to monitor for a signal pattern indicative of an RFID tag contained within medication; and
a processor to determine a status based on a detection or an absence of the signal pattern.

10. The apparatus as recited in claim 9, the processor further to identify an RFID of the medication and an expected change in a signal strength over time.

11. The apparatus as recited in claim 9, wherein to determine the status, the processor is further to determine the absence of the signal pattern when a particular signal pattern is expected.

12. The apparatus as recited in claim 9, wherein to determine the status, the processor is further to determine the presence of the signal pattern when the signal pattern is not expected.

13. The apparatus as recited in claim 9, the processor further to compare a detected signal pattern to a stored ingestion profile to identify a consumed medication.

14. The apparatus as recited in claim 13, wherein the stored ingestion profile includes an expected RFID.

15. The apparatus as recited in claim 13, wherein the consumed medication is compared to a patient medication profile to identify a deviation from expected medicating.

16. The apparatus as recited in claim 9, the processor further to initiate an alert if the status indicates an incorrect medicating.

17. The apparatus as recited in claim 9, wherein the RFID reader is further to record changes in a signal strength of the signal pattern over time.

18. An article comprising a storage medium having instructions stored thereon that, when executed by a computing platform, operate to:
monitor for a signal pattern indicative of a radio frequency identification (RFID) tag contained within medication; and
determine a status based on a presence or an absence of the signal pattern.

19. The article as recited in claim 18, wherein instructions to determine the status comprise instructions to identify an RFID of the medication and an expected change in a signal strength over time.

20. The article as recited in claim 18, wherein instructions to determine the status comprise instructions to determine the absence of the signal pattern when a particular signal pattern is expected.

21. The article as recited in claim 18, wherein instructions to determine the status comprise instructions to determine the presence of the signal pattern when the signal pattern is not expected.

22. The article as recited in claim 18, wherein the instructions to determine the status comprise instructions to compare a detected signal pattern to a stored ingestion profile to identify a consumed medication.

23. The article as recited in claim 22, wherein the stored ingestion profile includes an expected RFID.

24. The article as recited in claim 22, wherein the consumed medication is compared to a patient medication profile to identify a deviation from expected medicating.

25. The article as recited in claim 22, the instructions further comprising instructions to initiate an alert if the status indicates an incorrect medicating.

26. A system comprising:
a radio frequency identification (RFID) device to monitor for a signal pattern indicative of an RFID tag contained within a medication and initiate an alert if an improper medicating is detected.

27. The system as recited in claim 26, the RFID device to identify an RFID of the medication and an expected change in a signal strength over time.

28. The system as recited in claim 26, wherein to detect the improper medicating the RFID device further to determine the absence of the signal pattern when a particular signal pattern is expected.

29. The system as recited in claim 26, wherein to detect the improper medicating the RFID device further to determine the presence of the signal pattern when the signal pattern is not expected.

30. The system as recited in claim 26, the RFID device further to compare a detected signal pattern to a stored ingestion profile to identify a consumed medication.

31. The system as recited in claim 30, wherein the stored ingestion profile includes an expected RFID.

32. The system as recited in claim 30, wherein the consumed medication is compared to a patient medication profile to identify a deviation from expected medicating.
